(19) United States
(12) Patent Application Publication
(10) Pub. No.: US 2018/0327641 A1
(43) Pub. Date: Nov. 15, 2018

(54) PHOTOPOLYMERISABLE ADHESIVE COMPOSITION

(71) Applicant: Arkema France, Colombes (FR)

(72) Inventors: Raber INOUBLI, Pau (FR); Christian BRET, Bordeaux (FR); Olivier FRADIN, Pessac (FR); Nicolas VALLOIR, Gradignan (FR); Mathieu ROUX, Cerons (FR); Emilie VAIQUE, Peujard (FR)

(73) Assignee: Arkema France, Colombes (FR)

(21) Appl. No.: 15/756,861

(22) PCT Filed: Aug. 25, 2016
(86) PCT No.: PCT/FR2016/052124

§ 371 Date: Mar. 1, 2018

(30) Foreign Application Priority Data
Sep. 4, 2015 (FR) 1558206

(51) Int. Cl. C09J 153/00; C09J 4/06

(52) U.S. Cl. CPC C09J 153/00; C09J 4/06; C08K 5/092; C09J 2205/31; C09J 2433/00

(57) ABSTRACT

The present invention relates to a photopolymerizable adhesive composition containing a (meth)acrylic matrix, a (meth)acrylic block copolymer or a blend of (meth)acrylic block copolymers, and one or more photoinitiator(s).

### TECHNICAL FIELD OF THE INVENTION

The invention relates to an adhesive composition which can be cured by electromagnetic radiation of the gamma, IR, visible or UV type.

The invention more particularly relates to a photopolymerizable adhesive composition based on a (meth)acrylic matrix capable of being polymerized under light radiation and more particularly under UV radiation. Such a composition has numerous applications in varied fields, such as, for example, the cosmetics industry, in particular for the preparation of perfume bottles, or also the electronics industry, for the manufacture or the assembling of electronic components.

### PRIOR ART

Adhesive compositions, or more simply “adhesives”, based on acrylic compositions are known as “two-component” when the mixing of the base resin and of the hardener is carried out at the time of the adhesive bonding, in order to initiate the crosslinking of the polymer, or “one-component” when they are in the form of a single ready-for-use mixture.

Two-component adhesives, also known as “structural adhesives”, comprise a first component of resin type generally comprising a matrix of monomers associated with one or more polymers, and also a second component of initiator type. The initiator is intended to be brought into contact with the resin in order to initiate the polymerization of the monomers which it contains, making it possible for the adhesive to cure. The combination forms a crosslinked polymer network and the adhesive consequently fulfils its bonding role. However, these two-component systems exhibit by nature the disadvantage of requiring, before they are used, independent storage of the two components, thus preventing any contact between them and the polymerization of the monomers of the resin. Furthermore, the use of two-component adhesives is relatively restricting as it requires two impregnations of the surfaces or elements to be adhesively bonded: a first impregnation by the resin, followed by a second impregnation by the initiator. This takes time and results in major costs.

The document WO12131185 describes the preparation of such structural adhesives, in which the introduction of a (meth)acrylic block copolymer, which is nanostructured, by phase segregation between the blocks, into the thermosetting matrix makes it possible to obtain a compromise between the tensile-shear modulus and the elongation at break.

The one-component adhesives comprise a single mixture jointly comprising the resin and the initiator. The monomers of the resin are subsequently polymerized according to several different routes which do not require the addition of a subsequent chemical compound. The polymerization can be initiated, for example, by the thermal route via an increase in the temperature or else by exposure of the adhesive to light and in particular to ultraviolet (UV) rays.

The one-component adhesives, the polymerization of which is initiated by exposure of the adhesive to light, are known as “photopolymerizable” adhesives. The constituent monomers of the matrix are generally intended to form thermosetting polymers by crosslinking of the polymer chains. They are thus also called “photocrosslinkable” adhesives. Such adhesives make possible a significant saving in time, in comparison with two-component adhesives, and make possible a rapid and complete polymerization by simple exposure to light, rendering them very simple to employ.

However, photopolymerizable adhesives, and in particular the three-dimensional polymeric network obtained after crosslinking by exposure to UV radiation, are generally not very sturdy, indeed even brittle. They generally have physicochemical properties and in particular mechanical properties which are inferior to those of the two-component adhesives and may thus prove to be unsuitable for certain industrial applications requiring elevated physicochemical properties. The performance of these adhesives is more particularly related to their Young's modulus and to their elongation. In point of fact, in the case of photopolymerizable adhesives having a methacrylic matrix, the Young's modulus (also denoted by tensile modulus) is generally fairly high, of the order of 200 MegaPascals (MPa), whereas their elongation generally remains too low and less than 40%. It would thus be advisable to obtain a better compromise between these two characteristics and in particular a Young's modulus and an elongation which are both high.

The photopolymerizable adhesive must in addition be able to withstand aging, both thermal aging and weathering, while retaining good tensile-shear properties, to exhibit a good dimensional stability and in particular a very low sensitivity to water absorption, and to exhibit properties of transparency in order to be able to produce adhesive seals which are completely invisible.

### Technical Problem

It is thus an aim of the invention to overcome the disadvantages of the prior art by providing a photopolymerizable adhesive composition, based on a (meth)acrylic matrix, having improved physicochemical properties and in particular transparency properties, a high elongation at break, a high Young's modulus, elevated tensile-shear performance qualities, whatever the thermal and weather conditions, and a very low sensitivity to moisture, which is reflected by a low absorption of water by the photopolyrnerizable adhesive composition.

### BRIEF DESCRIPTION OF THE INVENTION

To this end, a subject matter of the invention is a photopolymerizable adhesive composition comprising a (meth)acrylic matrix, mainly characterized in that it additionally comprises a (meth)acrylic block copolymer or a blend of (meth)acrylic block copolymers, and one or more photoinitiator(s).

According to other optional characteristics of the adhesive composition, to be considered in isolation or in combination:
the (meth)acrylic matrix comprises one or more acrylic or methacrylic monomers and one or more acrylic or methacrylic oligomers;
advantageously, the (meth)acrylic block copolymer(s) is (are) chosen from block copolymers exhibiting one of the following structures: B-M, M-B-M, in which:
   each block is connected to the other by means of a covalent bond or of an intermediate molecule connected to one of the blocks by a covalent bond and to the other block by another covalent bond,
   M is a polymer block of polymethyl methacrylate (PMMA), namely a homopolymer or a copolymer comprising at least 50% by weight of methyl methacrylate,
   B is an elastomeric polymer block incompatible with the (meth)acrylic matrix and with the M block, and the glass transition temperature (Tg) of which is less than ambient temperature, advantageously less than 0° C. and preferably less than −20° C.;
the (meth)acrylic copolymer(s) comprises only (meth)acrylic blocks, that is to say that all its blocks are polymers or copolymers predominantly comprising (meth)acrylic monomers;
the (meth)acrylic block copolymer(s), and also the constituent monomers and/or oligomers of the (meth)acrylic matrix, may be functionalized;
the (meth)acrylic matrix is a thermosetting matrix and the (meth)acrylic composition is photocrosslinkable;
the composition advantageously comprises (limits included):
   from 0.1% to 40%, preferably between 1% and 20%, advantageously between 5% and 15%, by weight, of (meth)acrylic block copolymer(s),
   from 5% to 80% by weight of acrylic and/or methacrylic monomers, preferably between 30% and 70% by weight,
   from 5% to 80% by weight of acrylic and/or methacrylic oligomers, preferably between 10% and 30% by weight,
   from 1% to 10% by weight, preferably between 5% and 7% by weight, of adhesion additives,
   from 0.5% to 10% by weight, preferably between 0.5% and 4% by weight, of one or more photoinitiators;
the composition additionally comprises from 0% to 10% by weight, preferably between 5% and 10% by weight, of physical and/or chemical rheological additives;
the photoinitiator(s) is (are) chosen from at least one of the following compounds:

benzophenone, phosphine oxide, α,α-dihydroxyketone and aminoketone, iodonium salt and phenylglyoxylate.

Other advantages and characteristics of the invention will become apparent on reading the following description, given by way of illustrative and nonlimiting example.

### DETAILED DESCRIPTION OF THE INVENTION

In the continuation of the description, “photopolymerizable composition” or “photocrosslinkable composition” is understood to mean a composition for which the initiation of the polymerization is triggered by exposure to electromagnetic radiation. Preferably, the initiation of the polymerization of the composition according to the invention is triggered by exposure to ultraviolet (UV) radiation.

The term “monomer” as used relates to a molecule which can undergo a polymerization.

The term “polymerization” as used relates to the process for conversion of a monomer or of a mixture of monomers into a polymer.

“Polymer” is understood to mean either a copolymer or a homopolymer.

“Copolymer” is understood to mean a polymer grouping together several different monomer units and “homopolymer” is understood to mean a polymer grouping together identical monomer units.

“Block copolymer” is understood to mean a polymer comprising one or more uninterrupted sequences of each of the separate polymer entities, the polymer sequences being chemically different from one another and being bonded to one another by a covalent bond. These polymer sequences are also known as polymer blocks.

The term “(meth)acrylic” as used relates to any type of acrylic and methacrylic compounds, polymers, monomers or oligomers. However, it would not be departing from the scope of the invention if the (meth)acrylic matrix and/or the (meth)acrylic block copolymer were to comprise up to 10% by weight, preferably less than 5% by weight, of other nonacrylic monomers chosen from the group: butadiene, isoprene, styrene, substituted styrene, such as α-methylstyrene or tert-butylstyrene, cyclosiloxanes, vinylnaphthalenes and vinylpyridines.

The term “thermoplastic polymer” as used relates to a polymer having a glass transition temperature Tg above ambient temperature.

The term “thermosetting polymer” as used relates to a plastic material which is converted irreversibly by polymerization into an insoluble polymer network.

Within the meaning of the invention, an “oligomer” is a polymer compound of small size, comprising between 2 and 30 monomers, that is to say the degree of polymerization of which is between 2 and 30.

For simplicity, the term Tg will be found subsequently to denote the glass transition temperature (Tg).

A subject matter of the invention is a photopolymerizable adhesive composition based on a (meth)acrylic matrix for carrying out in particular the adhesive bonding of various materials, exhibiting a rapid curing, and also an improved durability and resistance to elevated temperature and humidity conditions. In particular, the adhesive composition makes it possible to maintain the whole of the adhesive bonding and of the adhesively bonded elements and makes it possible for the adhesive bonding to withstand mechanical and thermal stresses. The adhesive-bonding elements can, for example, comprise any type of part made of materials chosen, for example, from glass, polystyrene, ABS, polyester, polycarbonate, aluminum, steel, stainless steel, galvanized steel and also polymethyl methacrylate (PMMA), and the like.

The photopolymerizable adhesive composition according to the invention advantageously comprises a (meth)acrylic block copolymer or a blend of (meth)acrylic block copolymers dissolved in a (meth)acrylic matrix itself comprising one or more (meth)acrylic monomers and one or more (meth)acrylic oligomers. In addition, the composition comprises one or more photoinitiators intended to make possible the initiation of the polymerization of the (meth)acrylic monomers and of the (meth)acrylic oligomers of the (meth)acrylic matrix by exposure to electromagnetic radiation and in particular to ultraviolet (UV) rays.

### The (Meth)Acrylic Block Copolymer

Reference will subsequently be made to a “(meth)acrylic copolymer” to denote a (meth)acrylic copolymer or a blend of (meth)acrylic copolymers.

The block copolymer is said to be “(meth)acrylic” in that at least one of its constituent blocks is a polymer or copolymer based on (meth)acrylic monomers.

The (meth)acrylic block copolymer is preferably chosen from block copolymers comprising one or more M blocks and one or more B blocks.

More particularly, the block copolymers exhibiting one of the following structures: B-M, M-B-M, in which each block is connected to the other by means of a covalent bond or of an intermediate molecule connected to one of the blocks by a covalent bond and to the other block by another covalent bond, and in which M is a polymer block of polymethyl methacrylate (PMMA) homopolymer or a copolymer comprising at least 50% by weight of methyl methacrylate, and in which B is an elastomeric polymer block incompatible with the (meth)acrylic matrix and with the M block, and the glass transition'temperature (Tg) of which is less than ambient temperature, advantageously less than 0° C. and preferably less than −20° C., will be chosen.

As regards the B-M diblock, the M block consists of methyl methacrylate monomers or contains at least 50% by weight of methyl methacrylate, preferably at least 75% by weight of methyl methacrylate. The other monomers constituting the M block can be acrylic or nonacrylic monomers.

Mention may be made, among the nonacrylic monomers which may constitute the M block, by way of nonlimiting example, of the monomers chosen from the group: butadiene, isoprene, styrene, substituted styrene, such as α-methylstyrene or tert-butylstyrene, cyclosiloxanes, vinylnaphthalenes and vinylpyridines.

Advantageously, the monomers which may constitute the M block are chosen from methyl methacrylate, ethyl methacrylate, methyl acrylate, ethyl acrylate, methacrylic acid, acrylic acid, propyl methacrylate, propyl acrylate, n-butyl acrylate, isobutyl acrylate, n-butyl methacrylate, isobutyl methacrylate, pentyl methacrylate, pentyl acrylate, hexyl methacrylate, hexyl acrylate, cyclohexyl acrylate, cyclohexyl methacrylate, isobornyl acrylate, isobornyl methacrylate, amides derived from acrylic acid or from methacrylic acid, such as N,N-dimethylacrylamide (DMA), 2-methoxyethyl acrylate or methacrylate, 2-aminoethyl acrylate or methacrylate, polyethylene glycol (PEG) (meth)acrylate, in which the PEG group has a molar mass ranging from 400 to 10 000 g/mol, and their mixtures.

The monomer used to synthesize the elastomeric B block can be an alkyl (meth)acrylate; the following Tg values, in brackets following the name of the acrylate, are obtained: ethyl acrylate (−24° C.), butyl acrylate (−54° C.), 2-ethylhexyl acrylate (−85° C.), hydroxyethyl acrylate (−15° C.) and 2-ethylhexyl methacrylate (−10° C.). Use is advantageously made of butyl acrylate. According to one embodiment, the B block additionally comprises up to 5% by weight of acrylic or nonacrylic monomers, such as acrylic acid, methacrylic acid, styrene, butadiene, a substituted styrene, isoprene, a cyclosiloxane, a vinylnaphthalene or a vinylpyridine.

The B-M diblock has a number-average molar mass which can be between 10 000 g/mol and 500 000 g/mol, preferably between 20 000 and 200 000 g/mol. The B-M diblock advantageously consists of a fraction by weight of M of between 5% and 95% and preferably of between 15% and 85%.

As regards the M-B-M triblock, M consists of the same monomers and optionally comonomers as the M block of the B-M diblock. The two M blocks of the M-B-M triblock can be identical or different. They can also be different in their molar mass but consist of the same monomers. The B block consists of the same monomers and optionally comonomers as the B block of the B-M diblock.

The M-B-M triblock has a number-average molar mass which can be between 10 000 g/mol and 500 000 g/mol, preferably between 20 000 and 200 000 g/mol. Advantageously, the M-B-M triblock has the following compositions in M and B expressed as a fraction by weight, the total being 100%:
M: between 10% and 80% and preferably between 15% and 70%.
B: between 90% and 20% and preferably between 85% and 30%.

The block copolymers used in the materials of the present invention can be manufactured by controlled radical polymerization (CRP), for example according to the processes described in the documents WO 96/24620 and WO 00/71501.

According to one embodiment, at least one among the M and B blocks is functionalized by means of one or more functional groups chosen from acid, amine, amide, epoxy and thiol functional groups, quaternary ammonium groups, chlorinated groups and fluorinated groups.

Preferably, the (meth)acrylic block copolymer comprises only (meth)acrylic blocks, that is to say that all its blocks are polymers or copolymers based on (meth)acrylic monomers. In particular, the B and M blocks of the B-M diblock or M-B-M triblock copolymer are polymers based on (meth)acrylic monomers.

According to one embodiment, the block copolymer does not comprise styrene monomers or functional groups.

Preferably, the photopolymerizable adhesive composition according to the invention comprises between 0.1% and 40% by weight of (meth)acrylic block copolymer dissolved in the (meth)acrylic matrix. More preferably still, it comprises between 1% and 20% and advantageously between 5% and 15% by weight of block copolymer.

### The (Meth)Acrylic Matrix

The (meth)acrylic monomers and oligomers are preferably chosen from alkyl acrylates and/or alkyl methacrylates. The constituent monomers of the matrix can be linear and/or branched aliphatic acrylic and/or methacrylic monomers, and/or cyclic methacrylate monomers, and/or aromatic methacrylate monomers.

Preferably, said (meth)acrylic monomer is chosen from acrylic acid, methacrylic acid, alkyl acrylic monomers, alkyl methacrylic monomers and their mixtures, the alkyl group containing from 1 to 22 linear, branched or cyclic carbons, the alkyl group preferably containing from 1 to 12 linear, branched or cyclic carbons. Advantageously, the (meth)acrylic monomers are chosen from the following groups:
esters of an alcohol (monofunctional ester) or polyol (polyfunctional ester) with acrylic or methacrylic acid, it being possible for the functionality to range from 1 to 6. Said alcohol or polyol can be alkoxylated (ethoxy or propoxy). Said alcohol or polyol can be be linear or branched and aliphatic or cycloaliphatic;
monofunctional or polyfunctional epoxy acrylates or methacrylates derived from the reaction of acrylic or methacrylic acid with a monoepoxidized or polyepoxidized compound;
urethane acrylates derived from the reaction of a hydroxylated acrylate or methacrylate (such as hydroxyalkyl acrylate or methacrylate with C₂ to C₄ alkyl, in particular hydroxyethyl acrylate or methacrylate, HEA or HEMA) with a preferably aliphatic or cycloaliphatic isocyanate or polyisocyanate;
aminoacrylates which are monofunctional or polyfunctional in acrylates, derived from the Michael addition of a secondary amine to a polyfunctional acrylate and partial saturation, by this addition, of the acrylate functional groups (with at least one if not several residual acrylate functional groups per aminoacrylate molecule).

The (meth)acrylic oligomers are chosen from the following groups:
polyether acrylates or methacrylates resulting from the esterification by acrylic or methacrylic acid of a polyether polyol or monool, with an Mn which can range up to 2000 (oligoether based on a C₂ to C₄ alkoxy unit, in particular polyoxyethylenes or polyoxypropylenes or oxyethylene/oxypropylene random or block copolyethers). The polyoxyethylene or polyoxypropylene is also referred to as polyethylene glycol or polypropylene glycol;
polyester acrylates or methacrylates derived from the esterification by acrylic or methacrylic acid of a polyester polyol or monool. Said polyesters are polycondensation products of a polyacid (diacid) and a polyol (diol) and can be of variable structure depending on the structures of these polyacid and/or polyol components;
polyurethane acrylates or methacrylates which can result from the esterification reaction of a polyurethane polyol or monool with acrylic or methacrylic acid or from the reaction between a polyurethane polyisocyanate prepolymer (oligomer) and a hydroxyalkyl acrylate or methacrylate;
epoxy acrylate oligomers resulting from the acrylation or methacrylation of a monoepoxidized or polyepoxidized oligomer (for example epoxidized oligodienes, such as epoxidized polybutadiene or epoxidized polyunsaturated oils);
acrylated or methacrylated acrylic oligomers, such as copolymers of glycidyl methacrylate (GLYMA) with another acrylic or methacrylic comonomer, by reaction with acrylic or methacrylic acid.

Preferably, the adhesive composition comprises from 5% to 80% by weight and more preferably from 30% to 70% by weight of (meth)acrylic monomers.

Preferably, the adhesive composition comprises from 5% to 80% by weight and more preferably from 10% to 30% by weight of (meth)acrylic oligomers.

Preferably, the matrix is entirely (meth)acrylic, so that the monomers and the oligomers which it comprises are all (meth)acrylic oligomers and monomers.

As regards the photoinitiator or photoinitiators, the latter are advantageously chosen from at least one of the following compounds: benzophenone, phosphine oxide, α,α-dihydroxyketone, aminoketone, iodonium salt and phenylglyoxylate.

Preferably, the adhesive composition comprises from 0.5% to 10% by weight and more preferably between 0.5% and 4% by weight of photoinitiator.

The adhesive composition according to the invention can additionally comprise other components, such as, for example, physical and/or chemical rheological additives, and adhesion additives.

Mention may be made, among the rheological additives, for example, of: pyrogenic silicas or modified ureas. Preferably, the adhesive composition comprises from 0% to 10% by weight and more preferably from 5% to 10% by weight of rheological additive.

Mention may be made, among the adhesion additives, for example, of: silanes, epoxy resins or phosphates. Preferably, the adhesive composition comprises from 1% to 10% by weight and more preferably from 2% to 7% by weight of adhesion additive.

### Examples of Experimental Tests Carried out on Several Adhesive Compositions

Different mechanical tests were carried out on the following four photocrosslinkable adhesive compositions:
F1 (comparative example): a photocrosslinkable adhesive composition based on a (meth)acrylic matrix in which a nonacrylic block copolymer comprising a styrene-butadiene-styrene (S-B-S) unit is dissolved.
F2 (comparative example): a photocrosslinkable adhesive composition based on a (meth)acrylic matrix comprising an oligomer with a urethane-acrylate unit and not comprising any block copolymer.
F3 (comparative example): a photocrosslinkable adhesive composition comprising a matrix of (meth)acrylic monomers and oligomers and not comprising a (meth)acrylic block copolymer.
F4: a photocrosslinkable adhesive composition according to the invention based on a (meth)acrylic matrix in which a (meth)acrylic block copolymer exhibiting a methyl methacrylate-butyl acrylate-methyl methacrylate (MMA-BuA-MMA) sequence is dissolved.

The different tests were carried out for the purpose of determining the elongation at break, the transparency, the sensitivity to water, the Young's modulus and the tensile-shear modulus after thermal aging and weathering of each of the adhesive compositions F1 to F4 obtained after crosslinking.
1) The elongation at break of each composition was measured in accordance with the standard ISO 527-1A. For this:
   The geometry of the test specimen is in the form of a dumbbell: l×w×t(mm)=100×10×4
   The tensile test is carried out on a universal testing machine (Instron ID 3369Q8308 system with 50 kN force sensor and the Bluehill software)
   The rate of displacement of the crosspiece is 10 mm.min⁻¹
   At ambient temperature (23° C.)
   Expression of the results: Calculation of the % of elongation at break: [(L (mm)−Lo (mm))/Lo (mm)]×100, with Lo: initial length, and L: displacement at break.
2) The transparency of each adhesive composition after crosslinking was measured starting from dumbbell test specimens, with a thickness equal to 4 mm, used for the preceding measurement of elongation at break. The adhesive composition is said to be “transparent” when it is capable of allowing light to pass. In the contrary case, it is said to be “opaque”. The transparency is assessed visually.
3) The absorption of water by each of the adhesive compositions after crosslinking was measured in accordance with the standard DIN EN ISO 62. For this:
   Manufacture of test specimens with dimensions:

l×w×t(mm)=50×50×4
After drying the polymer for 24 h 00, the test specimens are weighed on a balance (M0) and then immersed in demineralized water for 96 h
Once the immersion time has passed, the test specimens are dried in an oven at 50° C. for 24 h, then placed in a desiccator until they have returned to a temperature of 23° C. and then weighed again (M1).
Expression of the results: Calculation of the % of water absorption:

[(M1(g)−M0(g))/Mo(g)]×100.
4) The tensile modulus, also known as Young's modulus, was measured for each adhesive composition after crosslinking. For this:
   The geometry of the test specimen is in the form of a dumbbell:

l×w×t(mm)=100×10×4
The tensile test is carried out on a universal testing machine (lnstron ID 3369Q8308 system with 50 kN force sensor and the Bluehill software)
The rate of displacement of the crosspiece is 10 mm.min⁻¹
At ambient temperature (23° C.)
Expression of the results: the Young's modulus can be directly deduced from the stress/strain curve. It is proportional to the slope of the straight line in the elastic region.
5) The adhesive compositions were subsequently used in order to assemble a glass part and an aluminum (6060 type) part (the term 6060 refers to the type of aluminum alloy) according to the standard NF 1465. For this:
   Geometry of the test specimens made of aluminum:

l×w×t(mm)=100×25×2
The overlapping will be 312.5 mm² and the thickness guaranteed by a Teflon strip calibrated at 250 μm
The tensile test is carried out on a universal testing machine (Instron ID 3369Q8308 system with 50 kN force sensor and the Bluehill software)
Rate of displacement of the crosspiece: 5 mm.min⁻¹ for the tensile-shear
At ambient temperature (23° C.)
Expression of the results: the tensile-shear stress values of the adhesive bonding seal are read on the universal testing machine.
Different tests were then carried out for the different assemblages obtained in order to determine the tensile-shear performance qualities before and after thermal aging and weathering, the results of which are combined in table I below.
a) Tensile-shear (TS) at 23° C.: Tensile tests were carried out at 23° C. on the assemblages produced above, in accordance with the standard NF 1465. For this:
   Geometry of the test specimens made of aluminum:

l×w×t(mm)=100×25×2
The overlapping will be 312.5 mm² and the thickness guaranteed by a Teflon strip calibrated at 250 μm
The tensile test is carried out on a universal testing machine (Instron ID 3369Q8308 system with 50 kN force sensor and the Bluehill software)
Rate of displacement of the crosspiece: 5 mm.min⁻¹ for the tensile-shear
At ambient temperature (23° C.)
Expression of the results: the tensile-shear stress values of the adhesive bonding seal are read on the universal testing machine.
b) Tensile-shear (TS) postcuring: After resting at 23° C. for 18 hours, the assemblages are placed at 200° C. for 20 minutes and then at 23° C. for 12 hours. The tensile-shear tests are subsequently carried out in accordance with the standard NF 1465, in the same way as for the tests at 23° C.
c) Tensile-shear (TS) postaging D3: (the term D3 corresponds to an aging cycle of 72 h). After resting at 23° C. for 18 hours, the assemblages are subjected to the weathering test according to the standard NF EN ISO 9142. For this:
   The aging test is carried out on a Climats Excal 1411HA chamber.
   The aging conditions are:
      16 h at 40° C. and 90% relative humidity,
      3 h at −20° C. and 0% relative humidity,
      5 h at 70° C. and 50% relative humidity.
Once the weathering test is complete, the tensile-shear tests are carried out in accordance with the standard NF 1465, in the same way as for the tests at 23° C.

The results of the different measurements carried out on the different adhesive compositions are collated in table I below. The unit of the tensile-shear test is the MegaPascal (MPa). The terms “AF” (adhesive failure) and “FS” (failure of the substrate) correspond to the failure facies observed during the tensile-shear tests.

TABLE I

| | | | Young's | | | | Water |
|---|---|---|---|---|---|---|---|
| | | Elongation | modulus | TS | TS | TS post | absorption |
| Composition | Transparency | (%) | (MPa) | 23° C. | postcuring | D3 | (%) |
| F1 | Opaque/white | 180 | 0.9 | 4.0 AF | 1.0 AF | 2.0 AF | Not |
| | | | | | | | measured |
| F2 | Transparent | 180 | 3 | 4.6 FS | 1.0 AF | 3.0 AF | 1.5 |
| F3 | Transparent | 400 | 15 | 4.0 FS | 1.5 AF | 4.0 FS | 2.2 |
| F4 | Transparent | 400-450 | 9 | 4.2 FS | 4.0 FS | 4.0 FS | 0.5 |

The photocrosslinkable adhesive composition F4 according to the invention is transparent and has, in comparison with the compositions F1 and F2, a much higher elongation at break and also a much higher Young's modulus. The composition F4 also has much greater tensile-shear TS postcuring and postaging D3 values.

In comparison with the composition F3, the composition F4 according to the invention has a greater tensile-shear TS postcuring value and a lower water absorption percentage.

Consequently, the adhesive composition F4 according to the invention has an excellent compromise between the elongation at break and the stiffness (Young's modulus), the respective values of which are both high, conferring very good mechanical properties on it. Moreover, the adhesive composition F4 according to the invention has an excellent resistance to thermal aging and to weathering, and a low sensitivity to water.

1. A photopolymerizable adhesive composition comprising:
a thermosetting (meth)acrylic matrix,
a (meth)acrylic block copolymer or a blend of (meth)acrylic block copolymers, and
one or more photoinitiator(s),
wherein the thermosetting (meth)acrylic matrix comprises:
one or more acrylic or methacrylic monomers, and
one or more acrylic or methacrylic oligomers at a concentration of 10% to 30% by weight.

2. The photopolymerizable adhesive composition as claimed in claim 1, wherein the photopolymerizable adhesive composition comprises between 5% and 15% by weight of said (meth)acrylic block copolymer or blend of (meth)acrylic block copolymers.

3. The photopolymerizable adhesive composition as claimed in claim 1, wherein said (meth)acrylic block copolymer is selected from block copolymers exhibiting one of the following structures: B-M or M-B-M, in which:
each block is connected to the other by means of a covalent bond or by means of an intermediate molecule connected to one of the blocks by a covalent bond and to the other block by another covalent bond,
M is a polymer block of polymethyl methacrylate (PMMA) homopolymer or a copolymer comprising at least 50% by weight of methyl methacrylate,
B is an elastomeric polymer block incompatible with the thermosetting (meth)acrylic matrix and with the M block, and having a glass transition temperature (Tg) which is less than ambient temperature.

4. The photopolymerizable adhesive composition as claimed in claim 1, wherein all the blocks of said block copolymer are polymers or copolymers based on (meth)acrylic monomers.

5. The photopolymerizable adhesive composition as claimed in claim 1, wherein the oligomers and monomers constituting the thermosetting (meth)acrylic matrix are all (meth)acrylic oligomers and monomers.

6. The photopolymerizable adhesive composition as claimed in claim 1, wherein the thermosetting (meth)acrylic matrix and/or the (meth)acrylic block copolymer comprises up to 10% by weight by weight of other nonacrylic monomers selected from the group consisting of: butadiene, isoprene, styrene, substituted styrene, cyclosiloxanes, vinylnaphthalenes and vinylpyridines.

7. The photopolymerizable adhesive composition as claimed in claim 3, wherein the monomers constituting the M block are selected from the group consisting of methyl methacrylate, ethyl methacrylate, methyl acrylate, ethyl acrylate, methacrylic acid, acrylic acid, propyl methacrylate, propyl acrylate, n-butyl acrylate, isobutyl acrylate, n-butyl methacrylate, isobutyl methacrylate, pentyl methacrylate, pentyl acrylate, hexyl methacrylate, hexyl acrylate, cyclohexyl acrylate, cyclohexyl methacrylate, isobornyl acrylate, isobornyl methacrylate, amides derived from acrylic acid or from methacrylic acid, 2 methoxyethyl acrylate, 2-methoxyethyl methacrylate, 2-aminoethyl acrylate, 2-aminoethyl methacrylate, polyethylene glycol (PEG) (meth)acrylate, comprising a PEG group having a molar mass ranging from 400 to 10 000 g/mol, and mixtures thereof.

8. The photopolymerizable adhesive composition as claimed in claim 3, wherein the B block is a polymer of an alkyl (meth)acrylate selected from the group consisting of ethyl acrylate, butyl acrylate, 2-ethylhexyl acrylate, hydroxyethyl acrylate and 2-ethylhexyl methacrylate.

9. The photopolymerizable adhesive composition as claimed in claim 8, wherein the B block additionally comprises up to 5% by weight of acrylic or nonacrylic.

10. The photopolymerizable adhesive composition as claimed in claim 3, wherein at least one among the M and B blocks is functionalized by means of one or more functional groups selected from the group consisting of acid functional groups, amine functional groups, amide functional groups, epoxy functional groups, thiol functional groups, quaternary ammonium groups, chlorinated groups and fluorinated groups.

11. The photopolymerizable adhesive composition as claimed in claim 2, wherein said acrylic or methacrylic monomer is selected from the group consisting of acrylic acid, methacrylic acid, alkyl acrylic monomers, alkyl methacrylic monomers and their mixtures.

12. The photopolymerizable adhesive composition as claimed in claim 2, wherein said (meth)acrylic oligomers are selected from the group consisting of:
polyether acrylates and polyether methacrylates resulting from the esterification by acrylic acid or methacrylic acid of a polyether polyol or polyether monool, with an Mn up to 2000;
polyester acrylates and polyester methacrylates derived from the esterification by acrylic acid or methacrylic acid of a polyester polyol or polyester monool;
polyurethane acrylates and polyurethane methacrylates which can result from the esterification reaction of a polyurethane polyol or polyurethane monool with acrylic acid or methacrylic acid or from the reaction between a polyurethane polyisocyanate prepolymer (oligomer) and a hydroxyalkyl acrylate or hydroxyalkyl methacrylate;
epoxy acrylate oligomers and epoxy methacrylate oligomers resulting from the acrylation or methacrylation of a monoepoxidized oligomer or polyepoxidized oligomer;
acrylated acrylic oligomers and methacrylated acrylic oligomers.

13. The photopolymerizable adhesive composition as claimed in claim 1, wherein the photopolymerizable adhesive composition comprises:
from 5% to 15% by weight of (meth)acrylic block copolymer(s),
from 5% to 80% by weight of one or more acrylic monomers and/or methacrylic monomers,
from 10% to 30% by weight of one or more acrylic monomers and/or methacrylic oligomers,
from 1% to 10% by weight of one or more adhesion additives,
from 0.5% to 10% by weight of one or more photoinitiators.

14. The photopolymerizable adhesive composition as claimed in claim 13, wherein the photopolymerizable adhesive composition additionally comprises up to 10% by weight, of one or more physical and/or chemical rheological additives.

15. The photopolymerizable adhesive composition as claimed in claim 1, wherein the photoinitiator(s) is (are) selected from the group consisting of: benzophenone, phosphine oxide, α,α-dihydroxyketone and aminoketone, iodonium salt and phenylglyoxylate and combinations thereof.

16. The photopolymerizable adhesive composition as claimed in claim 2, wherein said acrylic or methacrylic monomer is selected from the group consisting of acrylic acid, methacrylic acid; esters of an alcohol or polyol with acrylic acid or methacrylic acid; esters of an alkoxylated alcohol or alkoxylated polyol with acrylic acid or methacrylic acid; monofunctional and polyfunctional epoxy acrylates and monofunctional and polyfunctional epoxy methacrylates derived from the reaction of acrylic or methacrylic acid with a monoepoxidized or polyepoxidized compound; urethane acrylates and urethane methacrylates derived from the reaction of a hydroxylated acrylate or hydroxylated methacrylate with an isocyanate or polyisocyanate; aminoacrylates which are monofunctional or polyfunctional in acrylates, derived from the Michael addition of a secondary amine to a polyfunctional acrylate and partial saturation, by this addition, of the acrylate functional groups, with at least one residual acrylate functional group per aminoacrylate molecule.

17. The photopolymerizable adhesive composition as claimed in claim 1, wherein the photopolymerizable adhesive composition comprises:
from 5% to 15% by weight of (meth)acrylic block copolymer(s),
from 30% to 70% by weight of one or more acrylic monomers and/or methacrylic monomers,
from 10% to 30% by weight of one or more acrylic monomers and/or methacrylic oligomers,
from 5% to 7% by weight of one or more adhesion additives,
from 0.5% to 4% by weight of one or more photoinitiators.
